(19) United States
(12) Patent Application Publication
(10) Pub. No.: US 2007/0246364 A1
(43) Pub. Date: Oct. 25, 2007

(54) Selectively placing catalytic nanoparticles of selected size for nanotube and nanowire growth

(76) Inventors: Islamshah S. Amlani, Chandler, AZ (US); Larry A. Nagahara, Phoenix, AZ (US); Ruth Yu-Ai Zhang, Gilbert, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/213,189

(22) Filed: Aug. 26, 2005

(51) Int. Cl. B03C 5/02

(52) U.S. Cl. 204/547

(57) ABSTRACT

A method is provided for selectively placing catalytic nanoparticles (22) for growing one dimensional structures (28) including nanotubes and nanowires. The method comprises providing a solution (23) including a plurality of catalytic nanoparticles (28) suspended therein. An alternating current is applied between two electrodes (12, 14) submersed in the solution (23), thereby positioning the plurality of catalytic nanoparticles (22) contiguous to the two electrodes (12, 14). A one dimensional nanostructure (28) is then grown from each of the catalytic nanoparticles (22).

### FIELD OF THE INVENTION

The present invention generally relates to growing one dimensional nanostructures, and more particularly to placing catalytic nanoparticles for the growth of one dimensional nanostructures.

### BACKGROUND OF THE INVENTION

One-dimensional nanostructures, such as belts, rods, tubes and wires, have become the latest focus of intensive research with their own unique applications. One-dimensional nanostructures are model systems to investigate the dependence of electrical and thermal transport or mechanical properties as a function of size reduction. In contrast with zero-dimensional, e.g., quantum dots, and two-dimensional nanostructures, e.g., GaAs/AlGaAs superlattice, direct synthesis and growth of one-dimensional nanostructures has been relatively slow due to difficulties associated with controlling the chemical composition, dimensions, and morphology. Alternatively, various one-dimensional nanostructures have been fabricated using a number of advanced nanolithographic techniques, such as electron-beam (e-beam), focused-ion-beam (FIB) writing, and scanning probe.

Carbon nanotubes are one of the most important species of one-dimensional nanostructures. Carbon nanotubes are one of four unique crystalline structures for carbon, the other three being diamond, graphite, and fullerene. In particular, carbon nanotubes refer to a helical tubular structure grown with a single wall (single-walled nanotubes) or multiple wall (multi-walled nanotubes). These types of structures are obtained by rolling a sheet formed of a plurality of hexagons. The sheet is formed by combining each carbon atom thereof with three neighboring carbon atoms to form a helical tube. Carbon nanotubes typically have a diameter in the order of a fraction of a nanometer to a few hundred nanometers. As used herein, a “carbon nanotube” is any elongated carbon structure.

Carbon nanotubes can function as either a conductor, like metal, or a semiconductor, according to the rolled shape and the diameter of the helical tubes. With metallic-like nanotubes, a one-dimensional carbon-based structure can conduct a current at room temperature with essentially no resistance. Further, electrons can be considered as moving freely through the structure, so that metallic-like nanotubes can be used as ideal interconnects. When semiconductor nanotubes are connected to two metal electrodes, the structure can function as a field effect transistor wherein the nanotubes can be switched from a conducting to an insulating state by applying a voltage to a gate electrode. Therefore, carbon nanotubes are potential building blocks for nanoelectronic and sensor devices because of their unique structural, physical, and chemical properties.

Another class of one-dimensional nanostructures is nanowires. Nanowires of inorganic materials have been grown from metal (Ag, Au), elemental semiconductors (e.g., Si, and Ge), III-V semiconductors (e.g., GaAs, GaN, GaP, InAs, and InP), II-VI semiconductors (e.g., CdS, CdSe, ZnS, and ZnSe) and oxides (e.g., SiO₂ and ZnO). Similar to carbon nanotubes, inorganic nanowires can be synthesized with various diameters and length, depending on the synthesis technique and/or desired application needs.

A carbon nanotube is also known to be useful for providing electron emission in a vacuum device, such as a field emission display. The use of a carbon nanotube as an electron emitter has reduced the cost of vacuum devices, including the cost of a field emission display. The reduction in cost of the field emission display has been obtained with the carbon nanotube replacing other electron emitters (e.g., a Spindt tip), which generally have higher fabrication costs as compared to a carbon nanotube based electron emitter.

Both carbon nanotubes and inorganic nanowires have been demonstrated as field effect transistors (FETs) and other basic components in nanoscale electronic such as p-n junctions, bipolar junction transistors, inverters, etc. The motivation behind the development of such nanoscale components is that “bottom-up” approach to nanoelectronics has the potential to go beyond the limits of the traditional “top-down” manufacturing techniques.

Another major application for one-dimensional nanostructures is chemical and biological sensing. The extremely high surface-to-volume ratios associated with these nanostructures make their electrical properties extremely sensitive to species adsorbed on their surface. For example, the surfaces of semiconductor nanowires have been modified and implemented as highly sensitive, real-time sensors for pH and biological species.

Some of the challenges faced in forming one-dimensional nanostructures are (1) the selection of an appropriate catalyst, (2) size of the catalyst nanoparticle, (3) placement of the catalyst nanoparticles in desired locations, and (4) precise control over the growth condition parameters.

In the case of carbon nanotubes, various catalytic material processes have been invoked even for a similar growth technique such as thermal chemical vapor deposition (CVD). For example, a slurry containing Fe/Mo or Fe nanoparticles served as a catalyst to selectively grow individual single walled nanotubes. However the catalytic nanoparticles usually are derived by a wet slurry route which typically has been difficult to use for patterning small features.

Another approach for fabricating nanotubes is to deposit metal films using ion beam sputtering to form catalytic nanoparticles. In an article by L. Delzeit, B. Chen, A. Cassell, R. Stevens, C. Nguyen and M. Meyyappan in Chem. Phys. Lett. 348, 368 (2002), CVD growth of single walled nanotubes at temperatures of 900° C. and above was described using Fe or an Fe/Mo bi-layer thin film supported with a thin aluminum under layer. However, the required high growth temperature prevents simple integration of carbon nanotube growth with other device fabrication processes.

Ni has been used as one of the catalytic materials for the bulk formation of single walled nanotubes during laser ablation and arc discharge processes as described by Thess et al. in Science, 273, 483 (1996) and by Bethune et al. in Nature, 363, 605 (1993). Thin Ni layers have been widely used to produce multiwalled carbon nanotubes via CVD. The growth of single walled nanotubes using an ultrathin Ni/Al bilayer film as a catalyst in a thermal CVD process has been demonstrated. The Ni/Al film deposited by electron-beam evaporation allows for easier control of the thickness and uniformity of the catalyst materials (U.S. Pat. No. 6,764,874). When the substrate is heated, the Al layer melts and forms small droplets which absorb the residual oxygen inside the furnace and/or from the underlying SiO₂ layer and oxidize quickly to form thermally stable Al₂O₃ clusters. This in turn provides the support for the formation of Ni nanoparticles which catalyze the growth of single walled nanotubes.

The diameters of single walled nanotubes and inorganic nanowires are proportionally related to the sizes of the catalytic nanoparticles used in CVD processes (L. An et al., “Synthesis of nearly uniform single-walled carbon nanotubes using identical metal containing molecular nanoclusters as catalysts”, J. Amer, Chem. Soc., Vol. 124, pp. 13688-13689, 2002). However, consistently uniform nanotubes and nanowires have not been produced because of the fairly broad diameter distributions of the nanoparticles used as catalysts.

Accordingly, it is desirable to provide a simple yet reliable technique to assemble catalytic nanoparticles selectively in desired locations for device applications. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for selectively placing catalytic nanoparticles for growing one dimensional structures including nanotubes and nanowires. The apparatus comprises providing a solution including a plurality of catalytic nanoparticles suspended therein. An alternating current is applied between two electrodes submersed in the solution, thereby positioning the plurality of catalytic nanoparticles contiguous to the two electrodes. A one dimensional nanostructure is then grown from each of the catalytic nanoparticles.

### BRIEF DESCRIPTION OF THE DRAWINGS

The present invention will hereinafter be described in conjunction with the following drawing figures, wherein like numerals denote like elements, and

FIG. 1 is a simplified cross-sectional view of an apparatus on which the exemplary method of the present invention may be applied;

FIG. 2 is a simplified isometric view of the apparatus of FIG. 1;

FIG. 3 is a simplified cross-sectional view of an apparatus on which an exemplary embodiment of the method has been applied;

FIG. 4 is a simplified cross-sectional view of an apparatus on which another exemplary embodiment of the method has been applied;

FIG. 5 is a simplified cross-sectional view of an apparatus on which yet another exemplary embodiment of the method has been applied; and

FIG. 6 is a simplified flow chart of the steps of an exemplary embodiment of the present invention; and

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

One dimensional nanostructures such as nanotubes and nanowires show promise for the development of molecular-scale sensors, resonators, field emission displays, and logic/memory elements. One dimensional nanostructures is herein defined as a material having a high aspect ratio of greater than 10 to 1 (length to diameter). Preparation of these nanostructures by chemical vapor deposition (CVD) has shown a clear advantage over other approaches. In addition, the CVD approach allows for the growth of fairly uniform one dimensional nanostructures by controlling the size of catalytic nanoparticles. For example, the diameters of single walled nanotubes are typically proportionally related to the sizes of the catalytic nanoparticles used in the CVD process. The positioning of the carbon nanotubes at specific locations has previously been challenging. The method disclosed herein positions catalytic nanoparticles at desired locations by the application of an alternating current (AC) field to conducting electrodes. Once the catalytic nanoparticles are positioned, carbon nanotubes may be grown using conventional CVD processes. Optionally, the size of the catalytic nanoparticles may be controlled by the frequency of the AC field, thereby controlling the size of the carbon nanotubes grown therefrom.

A one dimensional nanostructures growth technique is disclosed wherein catalytic nanoparticles of selected sizes may be placed in a desired position. With the appropriate choice of amplitude and frequency, the use of an AC bias dramatically enhances the placement of desired catalytic nanoparticles sizes.

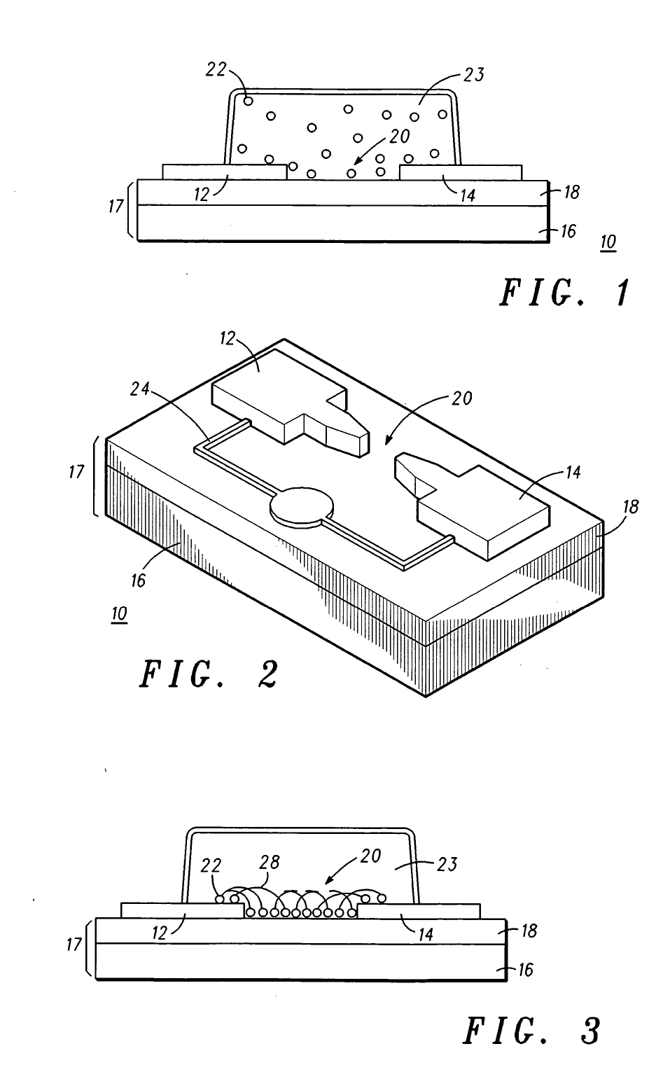

Referring now to FIG. 1, illustrated in simplified cross-sectional views, and in FIG. 2 in a partial perspective view, is an assembled structure utilized for selective placement of catalytic nanoparticles according to an exemplary embodiment of the present invention. More specifically, illustrated in FIG. 1 is an apparatus for selectively positioning catalytic nanoparticles, wherein provided is an assembly 10 including two or more electrodes 12, 14. Although electrodes 12, 14 are shown as positioned on insulating layer 18, they could be recessed or buried. Assembly 10 in this particular embodiment includes a substrate 17, comprising a semiconductor material 16 which has been coated with an insulating material 18. It should be understood that anticipated by this disclosure is an alternate embodiment in which substrate 17 is formed as a single layer of insulating material, such as glass, plastic, ceramic, or any dielectric material that would provide insulating properties. By forming substrate 17 of an insulating material, the need for a separate insulating layer formed on top of a semiconductive layer, or conductive layer, such as layer 18 of FIG. 1, is eliminated.

The semiconductor material 16 comprises any semiconductor material well known in the art, for example, silicon (Si), gallium arsenide (GaAs), germanium (Ge), silicon carbide (SiC), indium arsenide (InAs), or the like. Insulating material 18 is disclosed as comprising any material that provides insulative properties such silicon oxide (SiO₂), silicon nitride (SiN), or the like. The insulating material 18 comprises a thickness of between 2 nanometers and 10 microns. Semiconductor material 16 and insulating material 18 form substrate 17 as illustrated in FIGS. 1 and 2. In this specific example, assembly 10 includes a first electrode 12 and a second electrode 14 formed on an uppermost surface of insulating material 18. Fabrication of metal electrodes 12 and 14 is carried out using any form of lithography, for example, photolithography, electron beam lithography, and imprint lithography on an oxidized silicon substrate 17. In some embodiments, electrodes 12, 14 may comprise highly doped semiconductor material. Electrodes 12 and 14 comprise a thickness in the range of 1 nanometer to 5000 nanometers. Electrodes 12 and 14 are formed to define therebetween a gap 20 and provide for the application of an AC electric field (as illustrated in FIG. 2). The gap 20 between electrodes 12 and 14 may be between 1 nanometer and 100 microns.

The solution 23 is immiscible with catalytic particles 22 in a solution such as an aqueous environment (water based), or non-aqueous based on, for example, methanol, ethanol, or acetone. Examples of suitable catalytic particles 22 for nanostructure growth include titanium, vanadium, chromium, manganese, copper, zirconium, niobium, molybdenum, silver, hafnium, tantalum, tungsten, rhenium, gold, ruthenium, rhodium, palladium, osmium, iridium, platinum, nickel, iron, cobalt, or a combination thereof. More particularly for carbon nanotube growth, examples include nickel, iron, and cobalt, or combinations thereof. And for silicon nanowire growth, examples include gold or silver. The catalytic particles 22 may have a radius in the range of 0.5 to 100 nanometers, and preferably in the range of 1 to 5 nanometers for single walled nanotubes. The catalytic particles 22 may be spaced apart in the range of 1 to 100 nanometers, and preferably 5.0 nanometers.

During operation in accordance with an exemplary embodiment of the present invention as illustrated in FIG. 2, an AC field is applied between electrodes 12 and 14 thereby causing movement of catalytic nanoparticles 22 suspended within an aqueous environment 23 toward gap 20 where the field and/or field gradient is the strongest. It should be understood that anticipated by this disclosure is the use of any environment, such as liquid or gaseous in which nanometer-scale components are contained. More specifically, FIG. 2 illustrates catalytic nanoparticles 22 placed on electrodes 12 and 14 and on the insulating material 18. The catalyst 20 preferably comprises for carbon nanotube growth, for example, nickel, cobalt, iron, and a transition metal or oxides and alloys thereof. The AC field may be applied for a duration of only a second or two up to several minutes depending on catalytic nanoparticles 22 concentration in the solution 23, to position a desired number of the catalytic nanoparticles 22 in preferred locations. Optionally, a chemical functionalization step may be performed on the insulating layer 18 to immobilize, or attach, the catalytic nanoparticles 28 in preferred locations. Similarly, for positioning the catalytic nanoparticles 28 only on the electrodes 12 and 14, a chemical functionalization step may be performed on the insulating layer 18 to repel the catalytic nanoparticles 28 from the insulating layer 18 (FIG. 3).

Immediately prior to the application of an AC field, substrate 17 is cleaned, followed by a 20 minute soak in ethanol to remove oxidized Au. It should be understood that the amplitude of the AC bias, frequency and trapping time may vary, dependent upon the nature, desired size, and concentration of the catalytic nanoparticles and the dielectric environment in which the catalytic nanoparticles are contained. Placement time in this particular example is typically between 5 and 30 seconds. In principle, one may use a direct current (DC) field to trap catalytic nanoparticles in the gap, but such DC field is not the field of choice herein as use of a DC field will result in a success rate that is much lower as compared to an AC field. Under the influence of an AC field, catalytic nanoparticles 22 experience a dielectrophoretic force that pulls them in the direction of maximum field gradient found in gap 20.

After catalytic nanoparticles 22 positioning and removal of the solution 23, one dimensional nanostructures 28 are then grown from the catalytic nanoparticles 22 in a manner known to those skilled in the art, e.g., applying a gas comprising hydrogen and carbon for carbon nanotube growth. Although only a few catalytic nanoparticles 22 and one dimensional nanostructures 28 are shown, those skilled in the art understand that any number of catalytic nanotubes 22 and one dimensional nanostructures 28 could be formed.

The one dimensional nanostructures 28 may be grown, for example, as a field effect transistor for use in sensors or electronic circuits, or as conductive elements, in which case a one dimensional nanostructures 28 will be grown from one catalytic nanoparticle 22 to an electrode or to another one dimensional nanostructures 28 to form a electrical connection between electrodes as shown in FIGS. 2 and 3.

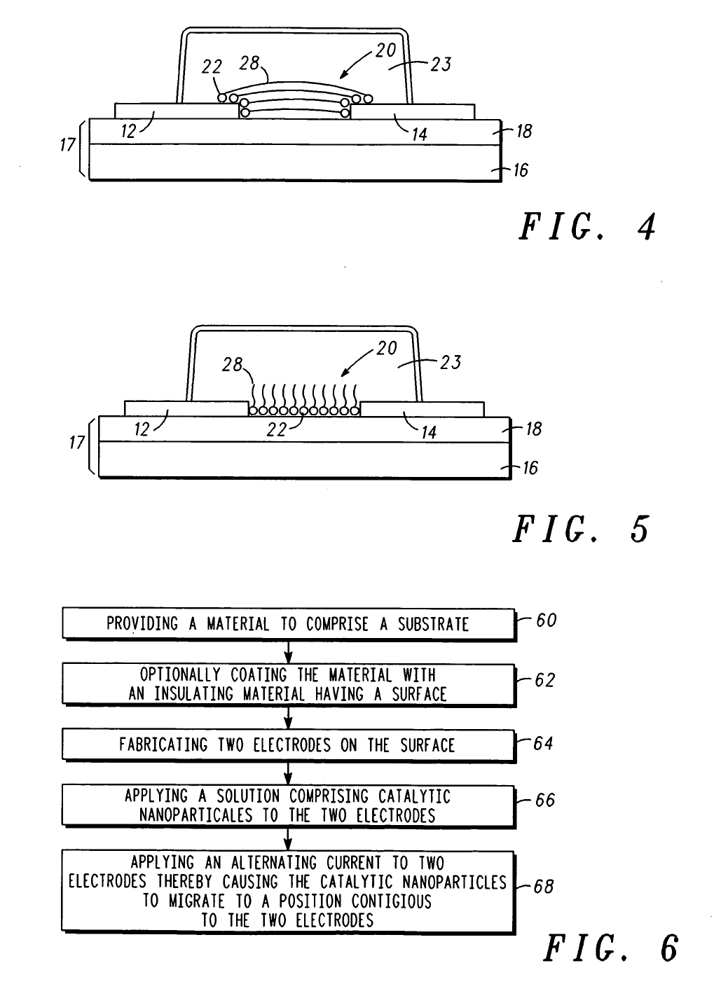

Alternatively, when used for a display device, the one dimensional nanostructures 28 may be grown in a vertical direction as illustrated in FIG. 4, for example. It should be understood that any one dimensional nanostructure 28 having a height to radius ratio of greater than 10, for example, would function equally well with some embodiments of the present invention.

The process is further illustrated by the flow chart 40 in FIG. 6 wherein a material 16 is provided 60 to form a substrate 17. The material 16 may be coated 62 with an insulating material 18. Two electrodes 12 and 14 are fabricated 64 on the substrate 17 surface. A solution 23 comprising catalytic nanoparticles 22 is applied 66 to the two electrodes 12 and 14. An alternating current is applied 68 to the electrodes 12 and 14 causing the catalytic nanoparticles 22 to migrate to a position contiguous to the electrodes 12 and 14.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method comprising:
providing a solution including a plurality of catalytic nanoparticles suspended therein; and
applying an alternating current between two electrodes submersed in the solution, thereby positioning the plurality of catalytic nanoparticles contiguous to the two electrodes; and
growing a one dimensional nanostructure from each of the catalytic nanoparticles.

2. The method of claim 1 further comprising growing a network of one dimensional nanostructures between the electrodes.

3. The method of claim 1 wherein the applying step comprises applying an alternating current for between one second and several minutes.

4. The method of claim 1 wherein the providing step comprises providing a solution including a plurality of catalytic nanoparticles having a radius in the range of 0.5 to 100 nanometers.

5. The method of claim 1 wherein the positioning step comprises positioning the plurality of catalytic nanoparticles having a distance therebetween on average in the range of 1 to 100 nanometers.

6. The method of claim 1 wherein the applying step comprises applying an alternating current between two electrodes spaced apart within the range of between 1 nanometer and 100 microns.

7. The method of claim 1 wherein the growing step comprises growing carbon nanotubes from catalytic nanoparticles comprising one of iron, nickel, cobalt, an oxide thereof, or a combination thereof.

8. The method of claim 1 wherein the applying step comprises applying an alternating current between two electrodes positioned one of on, within a recess, or buried on a substrate.

9. The method of claim 1 wherein the applying step comprises applying an alternating current between two electrodes comprising a doped semiconductor material.

10. A method comprising:
providing a solution including a plurality of catalytic nanoparticles suspended therein;
applying an alternating current between two electrodes submersed in the solution; and
applying one of a solution or a gaseous mixture to grow at least one of the plurality of one dimensional nanostructures on at least some of the catalytic nanoparticles.

11. The method of claim 10 further comprising growing a network of one dimensional nanostructures between the electrodes.

12. The method of claim 10 wherein the applying step comprises applying an alternating current for between one second and several minutes.

13. The method of claim 10 wherein the providing step comprises providing a solution including a plurality of catalytic nanoparticles having a radius in the range of 0.5 to 100 nanometers.

14. The method of claim 10 wherein the applying step comprises applying an alternating current between two electrodes spaced apart within the range of between 1 nanometer and 100 microns.

15. The method of claim 10 wherein the growing step comprises growing carbon nanotubes.

16. The method of claim 10 wherein the applying step comprises applying an alternating current between two electrodes positioned one of on, within a recess, or buried on a substrate.

17. The method of claim 10 wherein the applying step comprises applying an alternating current between two electrodes comprising a doped semiconductor material.

18. A method comprising:
forming two spaced apart electrodes on an insulating material;
immersing the two spaced apart electrodes in a solution including a plurality of catalytic nanoparticles;
applying an alternating current to create a field between the two spaced apart electrodes, the catalytic nanoparticles being attracted to the field and positioned one of on, between, or on and between the two spaced apart electrodes; and
growing a one dimensional nanostructure from at least some of the plurality of catalytic nanoparticles.

19. The method of claim 18 further comprising growing a network of one dimensional nanostructures between the electrodes.

20. The method of claim 18 wherein the applying step comprises applying an alternating current between two electrodes spaced apart within the range of between 1 nanometer and 100 microns.
